(19) United States
(12) Patent Application Publication
(10) Pub. No.: US 2017/0108130 A1
(43) Pub. Date: Apr. 20, 2017

(54) SHUTOFF VALVE IN BACKFLOW PREVENTION DEVICE

(71) Applicant: Douglas H. Powell, Eldorado Hills, CA (US)

(72) Inventor: Douglas H. Powell, Eldorado Hills, CA (US)

(21) Appl. No.: 14/884,594

(22) Filed: Oct. 15, 2015

(51) Int. Cl. F16K 15/02; F16K 3/04; F16K 3/32

(52) U.S. Cl. CPC F16K 15/02; F16K 3/32; F16K 3/04

(57) ABSTRACT

A backflow prevention device. The backflow prevention device includes a housing defining a water flow stream and an upstream shutoff valve, wherein the upstream shutoff valve is configured to allow a user to control water flow through the housing. The backflow prevention device further includes a downstream shutoff valve. At least on one of the shutoff valves includes an obstruction, wherein the obstruction is configured to prevent water flow at a first position, allow water flow at a second position and rotate from first position to second position about an axis of rotation. The axis of rotation is substantially parallel to the direction of the water flow stream as the water flow stream passes the obstruction and positioned such that the water flow stream passes the obstruction at openings spaced about the axis when in the second position.

### CROSS-REFERENCE TO RELATED APPLICATIONS

Not applicable.

### BACKGROUND OF THE INVENTION

Backflow prevention devices are widely used to prevent undesirable flow reversal under low flow, static or backpressure conditions wherein clean upstream fluid sources can be contaminated by downstream fluid. Backflow prevention devices typically comprise one or two check valves, housed within a valve body, which undergo closure under backflow, backpressure or back siphonage conditions. The use of backflow prevention devices is generally required by law for cross-connected water supplies where potable water could undergo contamination due to flow reversal or back pressure conditions.

Currently used double check valve backflow preventers have proved deficient in various respects. Particularly, such backflow preventers are prone to relatively high flow losses due to the valve configurations and closure mechanisms employed. Swing type check valves have excellent flow loss characteristics, however, they experience inconsistent closure and their complex mechanisms tend to wear over time. Poppet type have poor flow loss characteristics, however provide consistent closure and significantly less component wear.

Further, backflow preventer assemblies typically require a bulky, heavy housings, large access ports and separate access port cover. This type of housing is expensive to manufacture and requires a substantial amount of space to accommodate such features. Additionally, the cover typically undergoes a high amount of pressure requiring a thicker cover with more attachment points, which makes maintenance inconvenient and difficult.

In addition, backflow preventer assemblies typically require an inlet and an outlet shutoff valve in order to isolate internal check components during annual operational and functional testing. Shutoff valve types include gate valves, ball valves and butterfly valves. Each of these shutoff valves include and inlet port an outlet port and a main closure mechanism. Such features add substantial length and cost to the backflow prevention assembly.

Additionally, the increased length and material required in manufacture increases the weight of the backflow preventer assembly. This increases the difficulty in installing the backflow preventer assembly. Typically multiple people or an ad hoc support device are required simply to hold the assembly in the required position during assembly. This increases the installation time and cost.

Accordingly, there is a need in the art for a backflow preventer assembly which is compact and light weight. Further, there is a need in the art for a backflow preventer assembly which allows for accurate pressure measurement in each region, despite its compact nature. Moreover, there is a need in the art for a backflow preventer assembly which is easy and inexpensive to manufacture. Additionally, there is a need in the art for a backflow preventer assembly which provides easy access to internal check valves.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a backflow prevention device. The backflow prevention device includes a housing defining a water flow stream and an upstream shutoff valve, wherein the upstream shutoff valve is configured to allow a user to control water flow through the housing. The backflow prevention device also includes a check valve located within the housing downstream of the upstream shutoff valve. The check valve includes an orifice, wherein the orifice is configured for the flow of water through the check valve, and a clapper. The clapper is configured to allow water flow, in the downstream direction, through the orifice and prevent water flow, in the upstream direction, through the orifice. The backflow prevention device further includes a downstream shutoff valve. The downstream shutoff valve is located downstream of the check valve and configured to allow a user to control the water flow stream through the housing. At least on one of the shutoff valves includes an obstruction, wherein the obstruction is configured to prevent water flow at a first position, allow water flow at a second position and rotate from first position to second position about an axis of rotation. The axis of rotation is substantially parallel to the direction of the water flow stream as the water flow stream passes the obstruction and positioned such that the water flow stream passes the obstruction at openings spaced about the axis when in the second position.

Another example embodiment includes a backflow prevention device. The backflow prevention device includes a housing defining a water flow stream and an upstream shutoff valve, wherein the upstream shutoff valve is configured to allow a user to control water flow through the housing. The backflow prevention device also includes an upstream check valve located within the housing downstream of the upstream shutoff valve. The upstream check valve includes an orifice, wherein the orifice is configured for the flow of water through the upstream check valve, and a clapper. The clapper is configured to allow water flow, in the downstream direction, through the orifice and prevent water flow, in the upstream direction, through the orifice. The backflow prevention device also includes a downstream check valve located within the housing downstream of the upstream check valve. The downstream check valve includes an orifice, wherein the orifice is configured for the flow of water through the upstream downstream check valve a clapper. The clapper is configured to allow water flow, in the downstream direction, through the orifice and prevent water flow, in the upstream direction, through the orifice. The backflow prevention device further includes a downstream shutoff valve. The downstream shutoff valve is located downstream of the downstream check valve and configured to allow a user to control the water flow stream through the housing. At least one of the shutoff valves includes a surface placed substantially perpendicular to the direction of the water flow stream and one or more openings in the surface. The openings are spaced about a surface axis substantially parallel to the direction of the water flow stream when in the second position. At least one of the shutoff valves also includes an obstruction. The obstruction is configured to prevent water flow at a first position, where the first position is either behind or in front of the surface and allow water flow at a second position, wherein the second position is within the one or more openings and rotate from first position to second position about an axis of rotation. The axis of rotation is substantially parallel to the direction of the water flow stream as the water flow stream passes the obstruction.

Another example embodiment includes a backflow prevention device. The backflow prevention device includes a housing defining a water flow stream and an upstream shutoff valve, wherein the upstream shutoff valve is configured to allow a user to control water flow through the housing. The upstream shutoff valve includes a surface placed substantially perpendicular to the direction of the water flow stream and one or more openings in the surface. The openings are spaced about a surface axis substantially parallel to the direction of the water flow stream when in the second position. The upstream shutoff valve also includes an obstruction. The obstruction is configured to prevent water flow at a first position, where the first position is either behind or in front of the surface and allow water flow at a second position, wherein the second position is within the one or more openings and rotate from first position to second position about an axis of rotation. The axis of rotation is substantially parallel to the direction of the water flow stream as the water flow stream passes the obstruction. The backflow prevention device also includes an upstream check valve located within the housing downstream of the upstream shutoff valve. The upstream check valve includes an orifice, wherein the orifice is configured for the flow of water through the upstream check valve, and a clapper. The clapper is configured to allow water flow, in the downstream direction, through the orifice and prevent water flow, in the upstream direction, through the orifice. The backflow prevention device also includes a downstream check valve located within the housing downstream of the upstream check valve. The downstream check valve includes an orifice, wherein the orifice is configured for the flow of water through the upstream downstream check valve a clapper. The clapper is configured to allow water flow, in the downstream direction, through the orifice and prevent water flow, in the upstream direction, through the orifice. The backflow prevention device further includes a downstream shutoff valve. The downstream shutoff valve is located downstream of the downstream check valve and configured to allow a user to control the water flow stream through the housing. The downstream shutoff valve includes a surface placed substantially perpendicular to the direction of the water flow stream and one or more openings in the surface. The openings are spaced about a surface axis substantially parallel to the direction of the water flow stream when in the second position. The downstream shutoff valve also includes an obstruction. The obstruction is configured to prevent water flow at a first position, where the first position is either behind or in front of the surface allow water flow at a second position, wherein the second position is within the one or more openings and rotate from first position to second position about an axis of rotation. The axis of rotation is substantially parallel to the direction of the water flow stream as the water flow stream passes the obstruction.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a downstream perspective cutaway view of the example of a double check assembly;

FIG. 1B illustrates a side cutaway view of the example of a double check assembly;

FIG. 1C illustrates an upstream perspective cutaway view of the example of a double check assembly;

FIG. 2 illustrates an example of a double check assembly with a shutoff valve 108 which has been partially closed; and

FIG. 3 illustrates an example of a double check assembly with a shutoff valve 108 which has been completely closed.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

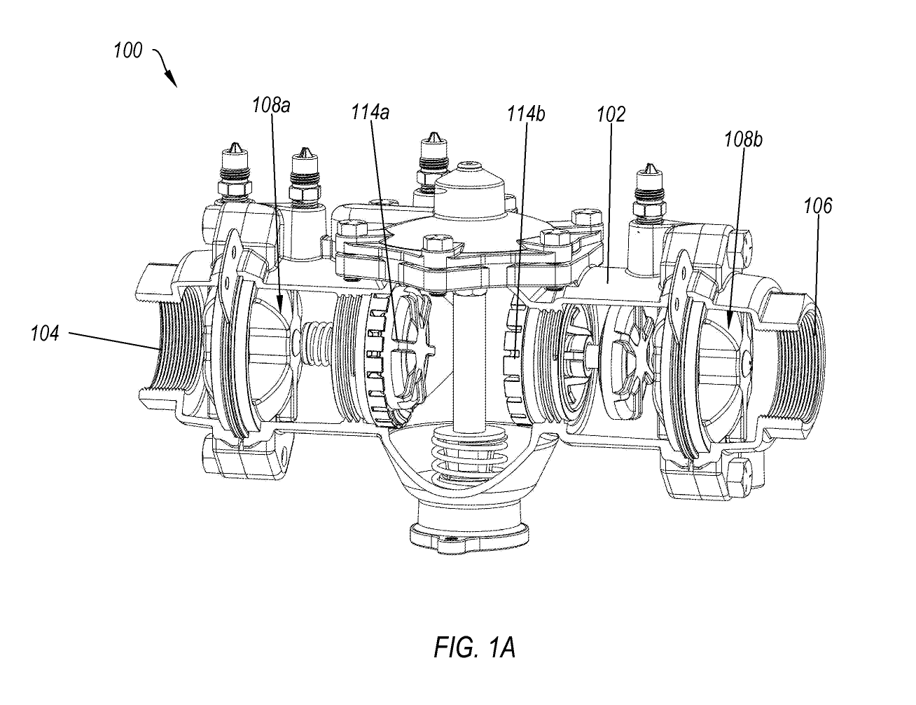

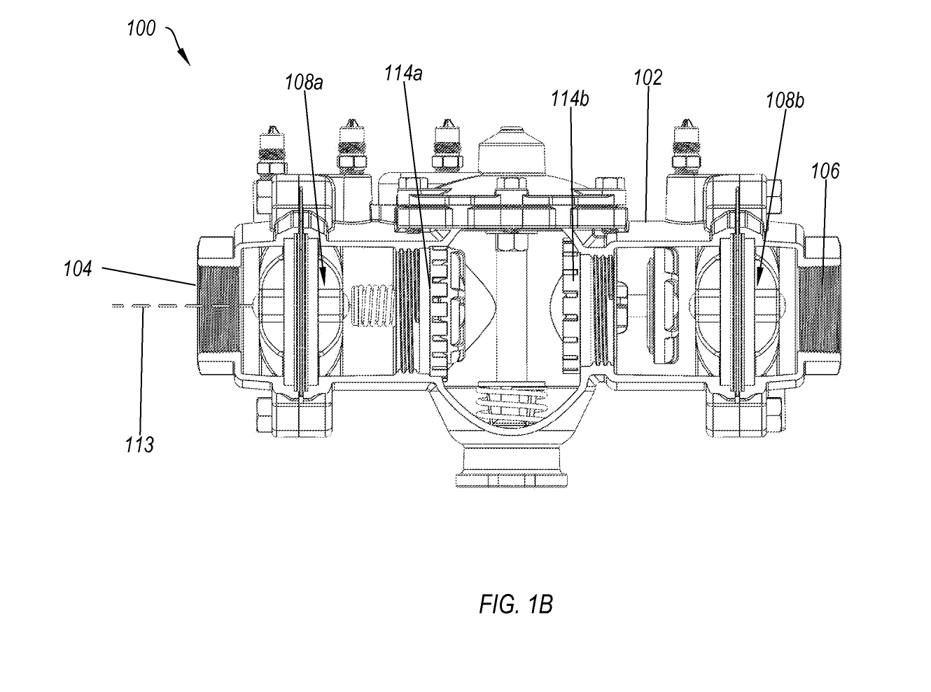

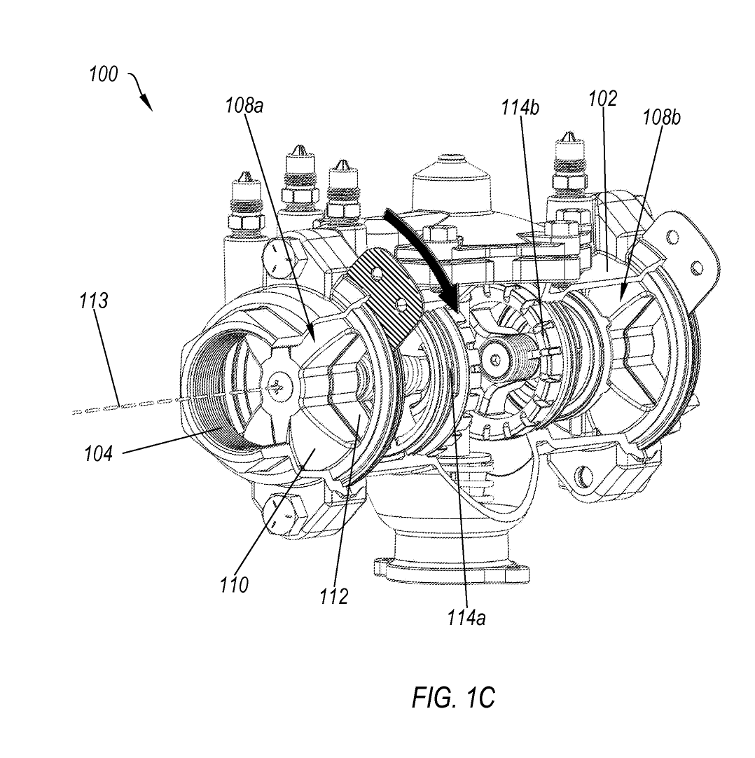

FIGS. 1A, 1B and 1C (collectively “FIG. 1”) illustrate an example of a double check assembly 100. FIG. 1A illustrates a downstream perspective cutaway view of the example of a double check assembly 100; FIG. 1B illustrates a side cutaway view of the example of a double check assembly 100; and FIG. 1C illustrates an upstream perspective cutaway view of the example of a double check assembly 100. In at least one implementation, the double check assembly 100 includes two check valves, which allow flow in one direction, but prevent flow in the opposite direction. The double check assembly is one example of a backflow prevention device which is configured to protect water supplies from contamination. In particular, the double check assembly 100 can include a backflow prevention redundancy. I.e., one check valve will still act, even if the other is jammed wide open.

FIG. 1 shows that the double check assembly 100 can include a housing 102. In at least one implementation, the housing 102 is configured to contain the water flow within the double check assembly 100. I.e., the housing 102 must be of sufficient strength to ensure that the double check assembly 100 can withstand the pressure of the water supply. Additionally or alternatively, the housing 102 is configured to align the other components of the double check assembly 100. I.e., the housing 102 can allow the internal and external components of the double check assembly 100 to be installed and proper spacing to be maintained among the components.

FIG. 1 also shows that the double check assembly 100 can include an inlet 104. In at least one implementation, the inlet 104 is configured to receive a water supply. I.e., the inlet 104 can be connected to a water supply and receive the water flow. In particular, the inlet 104 can include one or more coupling mechanisms which allow the double check assembly 100 to be connected to pipes, hoses or other devices which are configured to supply water. For example, the inlet 104 can include threading, grooves, flanges or other structures which allow attachment to the water supply.

FIG. 1 further shows that the double check assembly 100 can include an outlet 106. In at least one implementation, the outlet 106 is configured to output water. I.e., the outlet 106 can be connected as a water supply to a building or other area. In particular, the outlet 106 can include one or more coupling mechanisms which allow the double check assembly to be connected to pipes, hoses or other devices which are configured to receive water. For example, the outlet 106 can include threading, grooves, flanges or other structures which allow attachment to the water output.

FIG. 1 additionally shows that the double check assembly 100 can include an upstream shutoff valve 108a and a downstream shutoff valve 108b (collectively “shutoff valves 108”). In at least one implementation, the shutoff valves 108 can be used to control or regulate water flow through the double check assembly 100. I.e., a user can close the upstream shutoff valve 108a, the downstream shutoff valve 108b or both as needed to control water flow. For example, closure of the upstream and downstream shutoff valves 108 can allow maintenance of the double check assembly 100. Additionally or alternatively, shutoff of the downstream shutoff valve 108b can allow a user to shutoff water supply to the pipe, hose or other device connected to the outlet 106 and, therefore, any building or structure receiving the water supply. One of skill in the art will appreciate that the shutoff valves 108 can be located partially or completely within the housing or can be external to the housing, as desired.

FIG. 1 moreover shows that the shutoff valves 108 can include a surface 110. The surface 110 is placed substantially perpendicular to the direction of water flow through the housing 102 and prevents water flow through the housing 102. That is, where the surface 110 is present, water cannot flow through the housing 102.

FIG. 1 also shows that the shutoff valves 108 can include openings 112. The openings 112 are a passage through the surface 110 which allows water flow through the housing 102. That is, some water flow through the housing 102 is allowed to pass through the openings 112 while some is prevented by the surface 110. Thus, in fluid flow conditions all water is allowed to flow through the openings 112 such that the surface 110 cannot substantially restrict water flow. The openings 112 are spaced about an axis 113 that is parallel to the direction of water flow through the housing 102.

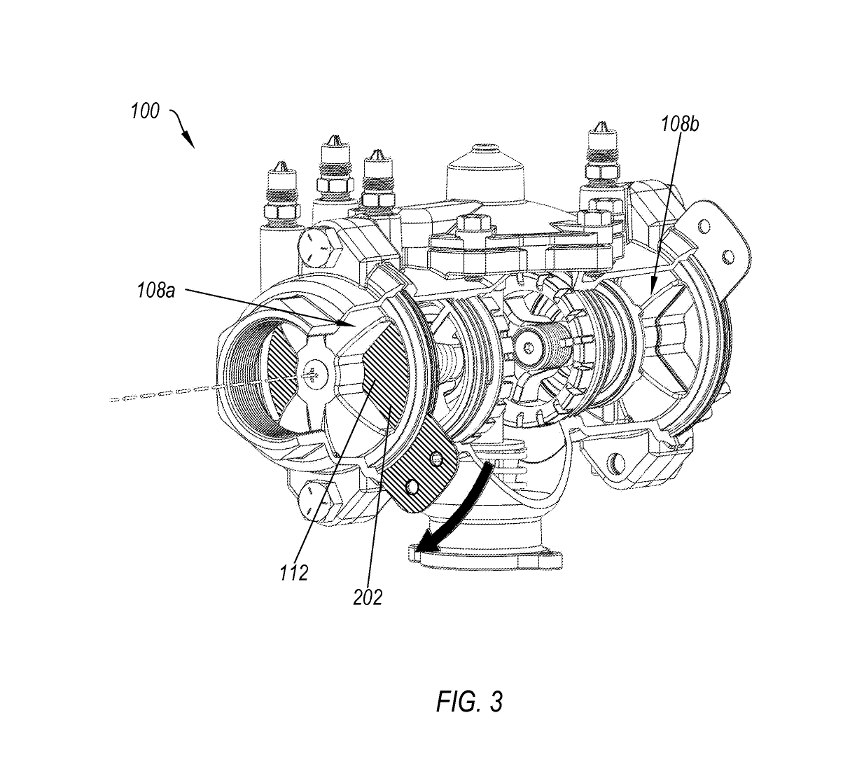

FIG. 1 moreover shows that the double check assembly 100 can include an upstream check valve module 114a and a downstream check valve module 114b (collectively “check valve modules 114”). In at least one implementation, the check valve modules 114 can prevent reverse flow within the reduced pressure assembly 200. I.e., the check valve modules 114 can be configured to allow water to flow in a forward direction (left to right as shown in FIGS. 3A and 3B) and prevent water flow in the reverse direction (right to left as shown in FIGS. 3A and 3B).

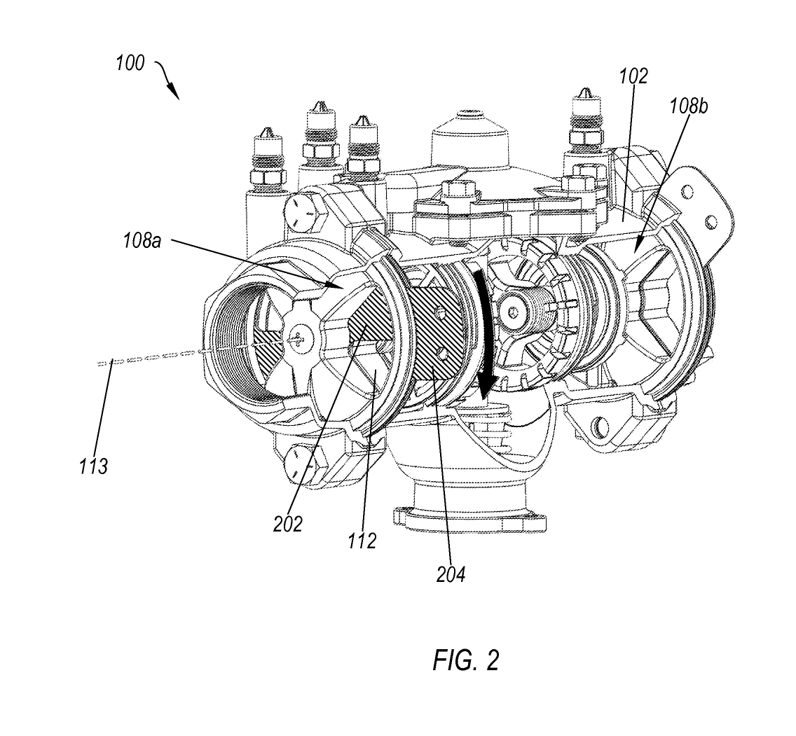

FIG. 2 illustrates an example of a double check assembly 100 with a shutoff valve 108 which has been partially closed. That is, the obstruction 202 has been rotated in the direction of the arrow in FIG. 2. Thus, in FIG. 2 approximately half of the openings 112 have been closed to water flow by the obstruction 202. Therefore, the water continues to flow but not at the same rate as when the shutoff valve is in the open position of FIG. 1.

FIG. 2 further shows that the shutoff valves 108 can include an obstruction 202. The obstruction 202 can be used to shutoff or allow the water flow through the housing 102. In particular, the obstruction 202 can be rotated about an axis 113 that is parallel to the direction of water flow through the housing 102. Thus, the obstruction 202 can either be behind the surface 110 where it will not obstruct any water flow or within the openings 112 where it will restrict some or all of the water flow.

FIG. 2 addition shows that the shutoff valves 108 can include a tab 204. The tab 204 can allow a user to move the position of the obstruction 202 relative to the surface 110. The tab 204 can be located external to the housing 102, allowing a user to easily control the water flow. That is, a user can move the tab 204 which in turn moves the obstruction 202 to block more or less of the water flow, as desired.

FIG. 3 illustrates an example of a double check assembly 100 with a shutoff valve 108 which has been completely closed. That is, the obstruction 202 has been rotated in the direction of the arrow in FIG. 3. Thus, in FIG. 3 the entirety of the openings 112 have been closed to water flow by the obstruction 202. Therefore, the water is prevented from flowing.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A backflow prevention device, the backflow prevention device comprising:
a housing defining a water flow stream;
an upstream shutoff valve, wherein the upstream shutoff valve is configured to allow a user to control water flow through the housing;
a check valve:
located within the housing downstream of the upstream shutoff valve; and
including:
an orifice, wherein the orifice is configured for the flow of water through the check valve; and
a clapper, wherein the clapper is configured to:
allow water flow, in the downstream direction, through the orifice; and
prevent water flow, in the upstream direction, through the orifice;
a downstream shutoff valve, wherein the downstream shutoff valve is:
located downstream of the check valve; and
configured to allow a user to control the water flow stream through the housing;
wherein at least on one of the shutoff valves includes an obstruction, wherein the obstruction is configured to:
prevent water flow at a first position;
allow water flow at a second position; and
rotate from first position to second position about an axis of rotation, wherein the axis of rotation is:
substantially parallel to the direction of the water flow stream as the water flow stream passes the obstruction; and
positioned such that the water flow stream passes the obstruction at openings spaced about the axis when in the second position.

2. The backflow prevention device of claim 1 further comprising:
a downstream check valve:
located within the housing downstream of the upstream check valve; and
including:
an orifice, wherein the orifice is configured for the flow of water through the upstream check valve; and
a clapper, wherein the clapper is configured to:
allow water flow, in the downstream direction, through the orifice; and
prevent water flow, in the upstream direction, through the orifice.

3. The backflow prevention device of claim 2, wherein the second check valve module is located within the housing upstream of the check valve module.

4. The backflow prevention device of claim 2, wherein the second check valve module is located within the housing downstream of the check valve module.

5. The backflow prevention device of claim 2 wherein the openings spaced symmetrically about the axis when in the second position are spaced at 90° intervals.

6. The backflow prevention device of claim 2 wherein the openings spaced symmetrically about the axis when in the second position are spaced at 120° intervals.

7. The backflow prevention device of claim 2 wherein the openings spaced symmetrically about the axis when in the second position are spaced at 180° intervals.

8. A backflow prevention device, the backflow prevention device comprising:
a housing defining a water flow stream;
an upstream shutoff valve, wherein the upstream shutoff valve is configured to allow a user to control water flow through the housing;
an upstream check valve:
located within the housing downstream of the upstream shutoff valve; and
including:
an orifice, wherein the orifice is configured for the flow of water through the upstream check valve; and
a clapper, wherein the clapper is configured to:
allow water flow, in the downstream direction, through the orifice; and
prevent water flow, in the upstream direction, through the orifice;
a downstream check valve:
located within the housing downstream of the upstream check valve; and
including:
an orifice, wherein the orifice is configured for the flow of water through the upstream check valve; and
a clapper, wherein the clapper is configured to:
allow water flow, in the downstream direction, through the orifice; and
prevent water flow, in the upstream direction, through the orifice;
a downstream shutoff valve, wherein the downstream shutoff valve is:
located downstream of the downstream check valve; and
configured to allow a user to control the water flow stream through the housing;
wherein at least on one of the shutoff valves includes:
a surface placed substantially perpendicular to the direction of the water flow stream;
one or more openings in the surface, wherein the openings are spaced about a surface axis substantially parallel to the direction of the water flow stream when in the second position; and
an obstruction, wherein the obstruction:
is configured to:
prevent water flow at a first position, where the first position is either behind or in front of the surface;
allow water flow at a second position, wherein the second position is within the one or more openings; and
rotate from first position to second position about an axis of rotation, wherein the axis of rotation is substantially parallel to the direction of the water flow stream as the water flow stream passes the obstruction.

9. The backflow prevention device of claim 8 further comprising:
a tab, wherein the tab allows a user to move the obstruction between the first position and second position.

10. The backflow prevention device of claim 9, wherein the tab is external to the housing.

11. A backflow prevention device, the backflow prevention device comprising:
a housing defining a water flow stream;
an upstream shutoff valve, wherein the upstream shutoff valve:
is configured to allow a user to control water flow through the housing; and
includes:
a surface placed substantially perpendicular to the direction of the water flow stream;
one or more openings in the surface, wherein the openings are spaced about a surface axis substantially parallel to the direction of the water flow stream when in the second position; and
an obstruction, wherein the obstruction:
is configured to:
prevent water flow at a first position, where the first position is either behind or in front of the surface;
allow water flow at a second position, wherein the second position is within the one or more openings; and
rotate from first position to second position about an axis of rotation, wherein the axis of rotation is substantially parallel to the direction of the water flow stream as the water flow stream passes the obstruction;
an upstream check valve:
located within the housing downstream of the upstream shutoff valve; and
including:
an orifice, wherein the orifice is configured for the flow of water through the upstream check valve; and
a clapper, wherein the clapper is configured to:
allow water flow, in the downstream direction, through the orifice; and
prevent water flow, in the upstream direction, through the orifice;
a downstream check valve:
located within the housing downstream of the upstream check valve; and
including:
an orifice, wherein the orifice is configured for the flow of water through the upstream check valve; and
a clapper, wherein the clapper is configured to:
allow water flow, in the downstream direction, through the orifice; and
prevent water flow, in the upstream direction, through the orifice;
a downstream shutoff valve, wherein the downstream shutoff valve:
is located downstream of the downstream check valve;
is configured to allow a user to control the water flow stream through the housing; and
includes:
a surface placed substantially perpendicular to the direction of the water flow stream;
one or more openings in the surface, wherein the openings are spaced about a surface axis substantially parallel to the direction of the water flow stream when in the second position; and
an obstruction, wherein the obstruction:
is configured to:
prevent water flow at a first position, where the first position is either behind or in front of the surface;
allow water flow at a second position, wherein the second position is within the one or more openings; and
rotate from first position to second position about an axis of rotation, wherein the axis of rotation is substantially parallel to the direction of the water flow stream as the water flow stream passes the obstruction.
